(19) United States
(12) Patent Application Publication
(10) Pub. No.: US 2010/0098931 A1
(43) Pub. Date: Apr. 22, 2010

(54) CARBON NANOTUBE FIBER-REINFORCED POLYMER COMPOSITES HAVING IMPROVED FATIGUE DURABILITY AND METHODS FOR PRODUCTION THEREOF

(75) Inventors: Davis C. Daniel, League City, TX (US); Justin W. Wilkerson, College Station, TX (US); Zhu Jiang, Missouri City, TX (US)

Correspondence Address: WINSTEAD PC, P.O. BOX 50784, DALLAS, TX, 75201, US

(73) Assignee: Texas A & M University System, College Station, TX (US)

(21) Appl. No.: 12/475,734

(22) Filed: Jun. 1, 2009

Related U.S. Application Data
(60) Provisional application No. 61/058,098, filed on Jun. 2, 2008.

(51) Int. Cl. B32B 27/06; B05D 1/36

(52) U.S. Cl. 428/300.1; 427/407.1

(57) ABSTRACT

Polymer composites and laminate materials are described herein. The composites and laminate materials include a fiber component, a polymer matrix component and a quantity of carbon nanotubes coating at least a portion of the fiber component. The fiber component can be a plurality of carbon fibers. The carbon nanotubes coating the fiber component strengthen a fiber-matrix interface between the fiber component and the polymer matrix component. Methods for improving the fatigue durability of a fiber-reinforced polymer composite are also disclosed.

### CROSS-REFERENCE TO RELATED APPLICATIONS

This application claims priority to U.S. provisional patent application 61/058,098 filed Jun. 2, 2008, which is incorporated by reference as if written herein in its entirety.

### STATEMENT REGARDING FEDERALLY SPONSORED RESEARCH

The present disclosure was funded in part with government support from the United States Air Force AFRL Contract No. FA8650-05-D-1912 and Department of Defense Air Force Office of Scientific Research/National Science Foundation Award No. 0453578. The federal government may have certain rights in embodiments of the disclosure described herein.

### BACKGROUND

Materials used in aerospace applications are subject to a number of forces, many of which are quasi-static or cyclical in nature. Some of these forces include shear, compression, tension and bending forces which lead to fatigue and ultimate failure of components. Fiber reinforced polymer composites (FRPC), particularly epoxy laminate composites, experience substantial use in aerospace applications due to their light weight and good mechanical strength under tensile loads. For example, it is estimated that the next generation of military and commercial aircraft may include more than 50% by weight of polymer composite materials. Many of these polymer composite materials will be carbon fiber and fiberglass composite materials.

Carbon fibers are particularly beneficial in FRPCs due to their high tensile strength and elastic modulus. Epoxy polymers, which are used in many FRPCs, typically have low tensile strength alone but provide bulk to the composite material and aid in load transfer to the fiber component. As a result, FRPCs having good tensile strength are obtained. Poor compression strength is a known weakness of carbon fibers and epoxy polymers, and FRPCs derived from these materials are likewise lacking in compression strength. As a result, FRPCs typically have substantially shorter failure lifetimes under quasi-static compression or cyclical tension-compression loading.

All materials ultimately experience mechanical failure under stress, and FRPCs are no exception. Since eventual failure under stress is an inherent property of any material, strategies to prevent catastrophic failure include: 1) exchanging out a component subject to failure at a time prior to estimated failure, and 2) extending the component's estimated failure lifetime beyond the useful operational lifetime of the device or system of which the component is a part. For metallic materials currently used as aerospace structural components, failure lifetimes typically exceed the useful operational lifetimes of commercial and military aerospace systems. Although metallic materials meet failure lifetime requirements, their low strength to weight ratios are detrimental in aerospace applications in terms of system performance and fuel consumption. Hence, the impetus for transitioning from metallic materials to FRPCs in aerospace applications is explained.

Failure mechanisms for FRPCs include fiber delamination, debonding of the fiber-matrix interface, fiber breakage, and normal and longitudinal fatigue crack growth throughout the polymer matrix. Tension-tension fatigue failure typically occurs via fiber failure, which is preceded by polymer matrix cracking, particularly along the fiber-matrix interface. Tension-compression fatigue failure typically occurs via polymer matrix cracking and fiber-matrix delamination, leading to fiber buckling and eventually specimen buckling in some cases.

In view of the foregoing, materials having improved strength and fatigue failure lifetimes are of considerable potential benefit in many applications. FRPCs having improved performance under quasi-static and cyclical tension-compression stress are of particular interest, given the known limitations of FRPCs in this regard. Accordingly, FRPCs having enhanced fatigue failure lifetimes under both tension-tension and tension-compression stress are described herein. The FRPCs described herein utilize carbon nanotubes as a constituent to enhance load transfer to the fiber component and inhibit fatigue failure mechanisms known to be problematic in existing FRPCs.

### SUMMARY

In various embodiments, polymer composites are disclosed herein. The polymer composites include a fiber component, a polymer matrix component, and a first quantity of carbon nanotubes. The polymer matrix component and the fiber component form a fiber-matrix interface. The first quantity of carbon nanotubes coats at least a portion of the fiber component. The fiber-matrix interface further includes the first portion of carbon nanotubes.

In other various embodiments, laminate materials are disclosed herein. The laminate materials include a fiber component having a plurality of layers and a polymer matrix component coating the plurality of layers. The fiber component includes a plurality of carbon fibers. At least a portion of the fiber component is coated with a first quantity of carbon nanotubes. The polymer matrix component and the plurality of carbon fibers form a fiber-matrix interface. The fiber-matrix interface further includes the first quantity of carbon nanotubes.

In various embodiments, methods for improving the fatigue durability of fiber-reinforced polymer composites are disclosed. The methods include providing a plurality of sheets of carbon fibers, coating at least a portion of the each of the plurality of sheets with carbon nanotubes, layering the plurality of sheets after the coating step, and forming the fiber-reinforced polymer composite. The forming step includes substantially uniformly coating the plurality of sheets with a polymer after the layering step. In particular, the each of the layered plurality of sheets is thoroughly wet with the polymer.

The foregoing has outlined rather broadly various features of the present disclosure in order that the detailed description that follows may be better understood. Additional features and advantages of the disclosure will be described hereinafter, which form the subject of the claims.

### BRIEF DESCRIPTION OF THE DRAWINGS

For a more complete understanding of the present disclosure, and the advantages thereof, reference is now made to the following descriptions to be taken in conjunction with the accompanying drawings describing specific embodiments of the disclosure, wherein:

FIG. 1 presents illustrative chemical structures of several different types of functionalized carbon nanotubes;

FIG. 2 presents a schematic of an illustrative spraying process for coating the fiber component of the polymer composites with carbon nanotubes;

FIG. 3 presents illustrative SEM images of uncoated carbon fibers, carbon fibers coated with unfunctionalized carbon nanotubes, carbon fibers coated with fluorinated carbon nanotubes and carbon fibers coated with amine-functionalized carbon nanotubes;

FIG. 4A presents a photograph of an illustrative H-VARTM system; FIG. 4B presents a side-view diagram of an illustrative H-VARTM system;

FIG. 5 presents an illustration showing the direction of polymer matrix component penetration through fiber component layers;

FIGS. 6A and 6B present illustrative designs and dimensions for CNFRPC and FRPC specimens tested herein;

FIGS. 7A and 7B present an illustrative schematic of a simulated fatigue crack and an optical microscopy image of actual fatigue crack progression in CNFRPCs;

FIGS. 8A and 8B present graphical illustrations of the improvement in tensile stiffness and tensile strength of CNFRPCs compared to FRPCs not containing carbon nanotubes;

FIG. 9 presents a schematic of an illustrative short beam shear (SBS) testing device for determining interlaminar shear cracking and failure;

FIG. 10 illustrates fracture modes observed for FRPCs and CNFRPCs under SBS testing conditions;

FIGS. 11A and 11B present illustrative tension-tension and tension-compression stress cycles;

FIGS. 12A and 12B present illustrative specimen displacements from the normal position under a tension-tension stress cycle and a tension-compression stress cycle;

FIG. 13 presents an illustrative plot of the number of cycles required for fatigue failure to occur under various tension-tension and tension-compression stresses;

FIG. 14 presents illustrative specimens displaying fiber rupture under tension-tension stress;

FIG. 15 presents illustrative specimens displaying buckling failure under tension-compression stress;

FIG. 16 presents an illustrative buckled specimen in the tension-compression testing apparatus;

FIGS. 17A and 17B present illustrative plots of the tension-tension failure lifetimes of CNFRPCs compared to FRPCs not containing carbon nanotubes;

FIG. 18 presents illustrative cross-sectional optical microscopy images of a failed FRPC specimen from quasi-static tensile testing;

FIG. 19 presents illustrative optical microscopy images of FRPCs showing normal and longitudinal crack progression along the fiber-matrix interface and fracture path under tension-tension stress;

FIG. 20 presents an illustrative optical microscopy image of CNFRPCs following tension-tension stress;

FIG. 21 presents illustrative SEM images of the fracture surfaces of FRPCs not containing carbon nanotubes and CNFRPCs following failure under tension-tension stress;

FIGS. 22A and 22B present illustrative plots of the increase in tension-compression fatigue failure lifetime of CNFRPCs compared to FRPCs not containing carbon nanotubes;

FIG. 23 presents an illustrative plot of normalized tension-compression fatigue lifetime at various failure cycles;

FIG. 24 presents illustrative SEM images of the fracture surface in CNFRPCs under tension-compression stress;

FIG. 25 presents illustrative midplane optical microscopy images of FRPCs and CNFRPCs following buckling failure under tension-compression stress; and

FIG. 26 presents illustrative Raster Scan Raman spectra and optical microscopy images of the polymer composites in the immediate vicinity of fatigue cracks.

### DETAILED DESCRIPTION

In the following description, certain details are set forth such as specific quantities, concentrations, sizes, etc. so as to provide a thorough understanding of the various embodiments disclosed herein. However, it will be apparent to those of ordinary skill in the art that the present disclosure may be practiced without such specific details. In many cases, details concerning such considerations and the like have been omitted inasmuch as such details are not necessary to obtain a complete understanding of the present disclosure and are within the skills of persons of ordinary skill in the relevant art.

Referring to the drawings in general, it will be understood that the illustrations are for the purpose of describing particular embodiments of the disclosure and are not intended to be limiting thereto. Furthermore, drawings are not necessarily to scale.

While most of the terms used herein will be recognizable to those of ordinary skill in the art, it should be understood that when not explicitly defined, terms should be interpreted as adopting a meaning presently accepted by those of ordinary skill in the art.

In various embodiments hereinbelow, reference is made to carbon nanotubes. The carbon nanotubes may be formed by any known technique and can be obtained in a variety of forms, such as, for example, soot, powder, fibers, bucky paper and mixtures thereof. The carbon nanotubes may be any length, diameter, or chirality as produced by any of the various production methods. In some embodiments, the carbon nanotubes have diameters in a range between about 0.1 nm and about 100 nm. In some embodiments, the carbon nanotubes have lengths in a range between about 100 nm and about 1 μm. In some embodiments, the chirality of the carbon nanotubes is such that the carbon nanotubes are metallic, semimetallic, semiconducting or combinations thereof. Carbon nanotubes may include, but are not limited to, single-wall carbon nanotubes (SWNTs), double-wall carbon nanotubes (DWNTs), multi-wall carbon nanotubes (MWNTs), shortened carbon nanotubes, oxidized carbon nanotubes, functionalized carbon nanotubes, purified carbon nanotubes, metalized carbon nanotubes and combinations thereof. Illustrative metalized carbon nanotubes are described in published PCT application WO 08/140,623, which is incorporated herein by reference. One of ordinary skill in the art will recognize that embodiments described hereinbelow using a particular type of carbon nanotube may be practiced within the spirit and scope of the disclosure using other types of carbon nanotubes.

In any of the various embodiments presented hereinbelow, the carbon nanotubes may be unfunctionalized (pristine) or functionalized. Functionalized carbon nanotubes, as used herein, refer to any of the carbon nanotubes types bearing chemical modification, physical modification or combination thereof. Such modifications can involve the nanotube ends, sidewalls, or both. Illustrative chemical modifications of carbon nanotubes include, for example, covalent bonding and ionic bonding. Illustrative physical modifications include, for example, chemisorption, intercalation, surfactant interactions, polymer wrapping, solvation, and combinations thereof. Unfunctionalized carbon nanotubes are typically isolated as aggregates referred to as ropes or bundles, which are held together through van der Waals forces. The carbon nanotube aggregates are not easily dispersed or solubilized. Chemical modifications, physical modifications, or both can provide individualized carbon nanotubes through disruption of the van der Waals forces between the carbon nanotubes. As a result of disrupting van der Waals forces, individualized carbon nanotubes may be dispersed or solubilized.

Unfunctionalized carbon nanotubes may be used as-prepared from any of the various production methods, or they may be further purified. Purification of carbon nanotubes typically refers to, for example, removal of metallic impurities, removal of non-nanotube carbonaceous impurities, or both from the carbon nanotubes. Illustrative carbon nanotube purification methods include, for example, oxidation using oxidizing acids, oxidation by heating in air, filtration and chromatographic separation. Oxidative purification methods remove non-nanotube carbonaceous impurities in the form of carbon dioxide. Oxidative purification of carbon nanotubes using oxidizing acids further results in the formation of oxidized, functionalized carbon nanotubes, wherein the closed ends of the carbon nanotube structure are oxidatively opened and terminated with a plurality of carboxylic acid groups. Illustrative oxidizing acids for performing oxidative purification of carbon nanotubes include, for example, nitric acid, sulfuric acid, oleum and combinations thereof. Oxidative purification methods using an oxidizing acid further result in removal of metallic impurities in a solution phase. Depending on the length of time oxidative purification using oxidizing acids is performed, further reaction of the oxidized, functionalized carbon nanotubes results in shortening of the carbon nanotubes, which are again terminated on their open ends by a plurality of carboxylic acid groups. The carboxylic acid groups in both oxidized, functionalized carbon nanotubes and shortened carbon nanotubes may be further reacted to form other types of functionalized carbon nanotubes. For example, the carboxylic acids groups may be reacted to form esters or amides, or they may be reacted in condensation polymerization reactions to form polymers having the carbon nanotubes bound to the polymer chains. Condensation polymers include, for example, polyesters and polyamides.

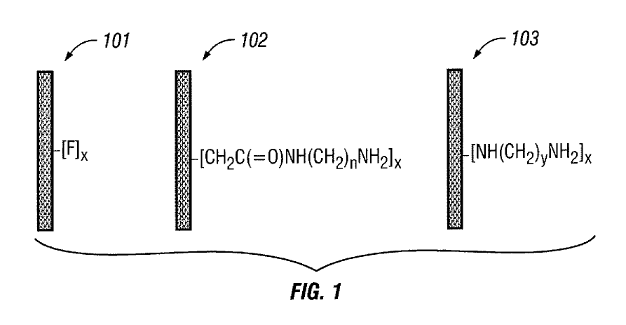

Other types of functionalized carbon nanotubes are also known in the art and may be utilized in any of the embodiments described herein. FIG. 1 presents illustrative chemical structures of several different types of functionalized carbon nanotubes. Illustrative functionalized carbon nanotubes utilized in embodiments described herein include, for example, fluorinated carbon nanotubes 101 and amino-functionalized carbon nanotubes 102 and 103. In FIG. 1, x is an integer used to indicate that the functionalized carbon nanotubes are functionalized with a plurality of functional groups. Fluorinated carbon nanotubes 101 are prepared by direct sidewall fluorination of carbon nanotubes using elemental fluorine. An illustrative procedure for preparing fluorinated carbon nanotubes 101 is described in U.S. Pat. No. 6,827,918, which is incorporated by reference in its entirety. Fluorination renders the carbon nanotubes more soluble than pristine carbon nanotubes. Further, the fluorine moieties are susceptible to displacement by nucleophiles such as, for example, amines, alkoxides and organometallic reagents to form other types of functionalized carbon nanotubes. For example, amino-functionalized carbon nanotube 103 may be formed by reaction of fluorinated carbon nanotube 101 with a diamine. In amino-functionalized carbon nanotube 103, y is an integer ranging from 2 to 20 in some embodiments, and in other embodiments from 2 to 6. Amino-functionalized carbon nanotubes 102 are formed by peroxide-mediated introduction of carboxylic acid groups on sidewalls of pristine carbon nanotubes, followed by amide-functionalization using a diamine. In amino-functionalized carbon nanotubes 102, n is an integer ranging from 1 to 10 in some embodiments, and in other embodiments from 1 to 2.

Functionalized carbon nanotubes may also be incorporated into polymers using standard polymerization techniques. The functionalized carbon nanotubes may be dispersed in the polymer and not covalently bound to the polymer chains. Alternately, the functionalized carbon nanotubes may be dispersed in the polymer and covalently bound to the polymer chains. For example, amino-functionalized carbon nanotubes 102 and 103 may react with epoxy resins through their amino groups. Similarly, fluorinated carbon nanotubes 101 may react with amino groups of epoxy curing agents to displace fluorines and form a cross-linked epoxy polymer covalently bound to the carbon nanotubes. One of ordinary skill in the art will recognize that the particular type of functionalized carbon nanotubes utilized in the various embodiments herein may be varied across a wide range of functionality, such variations residing within the spirit and scope of the disclosure. For example, one of ordinary skill in the art will recognize that desired solubility or reactivity properties of the functionalized carbon nanotubes will dictate the choice of functionalized carbon nanotube type utilized in the various embodiments herein.

Carbon nanotube fiber-reinforced polymer composites (CNFRPCs) are described herein. The CNFRPCs utilize nanotechnology enhancements to provide advantageous durability and structural stability improvements over conventional fiber-reinforced polymer composites (FRPCs) not containing carbon nanotubes. In particular, the CNFRPCs provide increased resistance to tension-tension and tension-compression fatigue failure compared to conventional FRPCs. Inclusion of carbon nanotubes at the fiber-matrix interface in CNFRPCs provides advantageous resistance to polymer matrix cracking, longitudinal cracking along the fiber-matrix interface, and fiber delamination, all of which are dominant failure mechanisms in conventional FRPCs. Thus, the CNFRPCs provide a nanotechnology solution to mitigating the evolution of failure mechanisms and extending failure lifetimes under fatigue loading. In various embodiments, polymer composites are disclosed herein. The polymer composites include a fiber component, a polymer matrix component, and a first quantity of carbon nanotubes. The polymer matrix component and the fiber component form a fiber-matrix interface. The first quantity of carbon nanotubes coats at least a portion of the fiber component. The fiber-matrix interface further includes the first portion of carbon nanotubes.

In various embodiments, the first quantity of carbon nanotubes includes, for example, single-wall carbon nanotubes, double-wall carbon nanotubes, multi-wall carbon nanotubes and combinations thereof. In various embodiments, the first quantity of carbon nanotubes includes functionalized carbon nanotubes. In various embodiments, at least a portion of the first quantity of carbon nanotubes is functionalized. In various embodiments, the first quantity of carbon nanotubes is covalently bonded to the polymer matrix component. Illustrative means for covalently bonding carbon nanotubes to the polymer matrix component are set forth hereinabove. Such covalent bonding may occur at room temperature or during heating. For example, such covalent bonding may occur under the heating conditions set forth hereinbelow for curing of the polymer composites. In various embodiments, the first quantity of carbon nanotubes is covalently bonded to the fiber component. In various embodiments, the first quantity of carbon nanotubes is covalently bonded to both the polymer matrix component and the fiber component.

In various embodiments of the polymer composites, the polymer component is a thermosetting polymer. In various embodiments, the thermosetting polymer includes an epoxy polymer. The epoxy polymer is formed by a curing reaction between at least one epoxy resin and at least one curing agent. A common epoxy resin used in aerospace applications is EPON 862. A common curing agent used in aerospace applications is curing agent compound W (diethylenetoluene diamine-—DETDA). The resultant polymer repeating unit from this combination follows below.

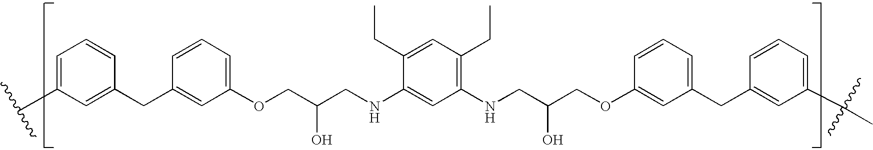

In various embodiments, the at least one epoxy resin and the at least one curing agent are combined and applied to the fiber component to form a pre-polymer composite. Curing takes place after the pre-polymer coats the fiber component to form the polymer composite. Curing may occur at room temperature or with heating. Heating can occur between about 25° C. and about 500° C. in some embodiments, between about 50° C. and about 350° C. in other embodiments, and between about 100° C. and about 300° C. in still other embodiments. During curing, the carbon nanotubes may become covalently bonded to the polymer matrix component in some embodiments. One of ordinary skill in the art will recognize that a number of different epoxy polymers formed from various epoxy resins and curing agents may be used in practicing the various embodiments of the disclosure. Although the embodiments hereinbelow are described using the epoxy polymer formed from EPON 862 and curing agent compound W, the disclosure should not be taken as limiting in this regard.

In other various embodiments of the polymer composites, the polymer component is a thermoplastic polymer. Illustrative thermoplastic polymers include, for example, polyethylene, polypropylene and nylons.

Various fiber components may be used in forming the polymer composites. Illustrative fiber components include, for example, glass fibers, carbon fibers, boron fibers, aluminum fibers, and KEVLAR (aramid polymers) fibers and combinations thereof. In various embodiments, the fiber component further includes a plurality of individual fibers. For example, the fiber component may include a plurality of individual fibers wound together as a yarn. Alternatively, the fiber component may include a plurality of individual fibers woven together as a fabric. The terms fabric and sheet will be used interchangeably herein. Unless specified otherwise, a reference to a fiber component, as used herein, will refer to any of individual fibers, yarns and sheets (fabrics). In various embodiments, the fiber component is a plurality of carbon fibers. In various embodiments, at least a portion of the plurality of carbon fibers is functionalized. In various embodiments, the carbon fibers are woven carbon fibers. An illustrative carbon fiber includes, for example, Hexel IM7 carbon fibers, a four harness satin weave carbon fiber. Hexel IM 7 is reported to have a specific strength of 20 times that of titanium and an elastic modulus of 276 GPa. Such carbon fibers are used in various embodiments of the polymer composites disclosed herein. In various embodiments, the fibers components are woven together to form a sheet of the fiber component (i.e., a fabric). The sheets may be layered in forming the polymer composites. Hence, laminate materials are disclosed herein. In various embodiments having layered sheets, the layered sheets are rotated about 90° relative to one another. The fiber components in alternating layers are oriented longitudinally and transverse to one another. In various embodiments of the disclosure, polymer composites having layered sheets of carbon fibers are disclosed. One of ordinary skill in the art will recognize that many different fiber components, particularly different types of carbon fibers, may be used to operate within the spirit and scope of the present disclosure.

In various embodiments, the fiber component further includes a plurality of carbon nanofibers in addition to the plurality of carbon fibers. As used herein, carbon nanofibers refer to, for example, a tubular carbon material that is generally, but not always, larger in diameter than carbon nanotubes. In various embodiments, the carbon nanofibers are between about 50 nm and about 300 nm in diameter. In other various embodiments, the carbon nanofibers are between about 100 nm and about 300 nm in diameter. In various embodiments of the polymer composites, the polymer composites include another nanocomponent in addition or replacing the carbon nanotubes. Nanocomponents include, for example, nanoparticles and fullerenes.

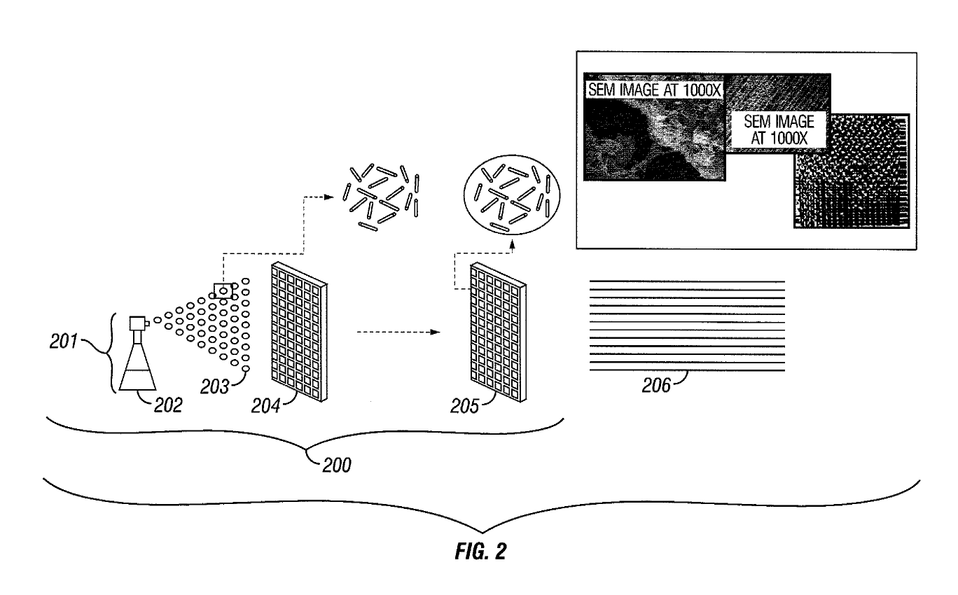

In various embodiments, the first quantity of carbon nanotubes is coated on to the fiber component by spraying. Such spraying methods for depositing carbon nanotubes are described in United States Patent Publication No. 20060166003, which is incorporated herein by reference in its entirety. FIG. 2 presents a schematic of an illustrative spraying process 200 for coating the fiber component of the polymer composites with carbon nanotubes. As shown in FIG. 2, a carbon nanotube solution 202 is prepared in a solvent such as, for example, ethanol and placed in sprayer 201. A carbon nanotube concentration in the solution may be about 1 mg/mL, for example. Solvation may be aided using, for example, high shear mixing and sonication. Typical solvents used for preparing the carbon nanotube solution 202 are those solvents that have good solubility for carbon nanotubes as well as sufficient volatility to be evaporated readily once sprayed. Carbon nanotube spray 203 is then applied to fiber component 204. As shown in FIG. 2, fiber component 204 is a fabric. After evaporation of the solvent, coated fiber component 205 is obtained. The coated fiber components 205 may be used individually or stacked in a plurality of layers 206 to form the polymer composites. Some or all of the plurality of layers 206 may have fiber components 205 coated with the carbon nanotubes. The inset shows an SEM image of coated fiber component 205.

In various embodiments of the polymer composites, the first quantity of carbon nanotubes coats at least a portion of the fiber component. A fiber component that is partially coated with carbon nanotubes has some areas of the fiber component covered with carbon nanotubes and other areas of the fiber component not covered with carbon nanotubes. In other words, the fiber-matrix interface of the polymer composites may include a plurality of interfaces, some of which include carbon nanotubes and others of which do not include carbon nanotubes at the fiber-matrix interface. In various embodiments of the present disclosure, at least a portion of the plurality of interfaces forming the fiber-matrix interface include carbon nanotubes. As Applicants demonstrate herein, carbon nanotubes strengthen of the fiber-matrix interface. Hence, in some embodiments of the disclosure, a uniform coating of carbon nanotubes on the fiber component may be advantageous. In various embodiments of the polymer composites, the first quantity of carbon nanotubes uniformly coats the fiber component. A uniform coating of carbon nanotubes, as used herein, refers to, for example, a condition in which all or substantially all of the fiber component is covered with carbon nanotubes. As used herein, “uniform coating” of the polymer matrix component refers to, for example, a condition in which substantially all of the fiber component layers are wetted with polymer matrix component. In various embodiments, a uniform coating includes between about 90% to 100% coverage of carbon nanotubes. In other various embodiments, a uniform coating includes between about 70% to about 90% coverage of carbon nanotubes. In various embodiments, a partial coating includes less than about 70% coverage of carbon nanotubes. For both partial and uniform carbon nanotube coatings, various thicknesses of the carbon nanotube coatings are useful in practicing the embodiments of the disclosure. Such variable thicknesses are determined by the weight percentage of carbon nanotubes chosen to form the polymer composite. Weight percentage refers to the weight of carbon nanotubes relative to the weight of the fiber component. Polymer composites having higher weight percentages of carbon nanotubes will have thicker carbon nanotube coatings on their fiber components compared to polymer composites prepared under similar conditions using a lower weight percentage of carbon nanotubes. Polymer composites having higher weight percentages of carbon nanotubes may provide superior mechanical properties compared to polymer composites having lesser weight percentages of carbon nanotubes. The superior mechanical properties result from increased strengthening of the fiber-matrix interface by the higher weight percentage of carbon nanotubes. In various embodiments, the polymer composites contain between about 0.1 to about 0.5 weight percent of carbon nanotubes. In other various embodiments, the polymer composites contain between about 0.2 to about 0.5 weight percent of carbon nanotubes. In still other various embodiments, the polymer composites contain greater than about 0.5 weight percent of carbon nanotubes. Although a focus of the work of the present disclosure has been on strengthening of the fiber-matrix interface, a further effect of the carbon nanotubes may be strengthening of the polymer matrix component as the weight percentage of carbon nanotubes increases.

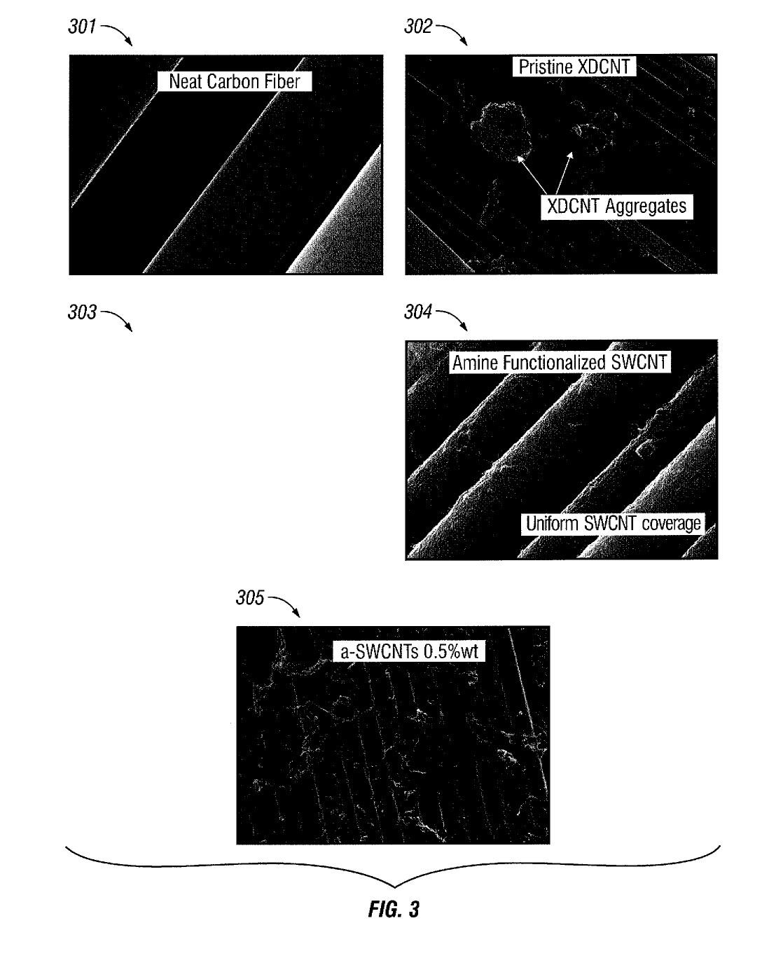

When the fiber component includes a plurality of carbon fibers, the first quantity of carbon nanotubes may coat the plurality of carbon fibers. In various embodiments, the first quantity of carbon nanotubes coats at least a portion of the plurality of carbon fibers. In other various embodiments, the first quantity of carbon nanotubes uniformly coats the plurality of carbon fibers. Applicants' definition of a uniform coating is set forth hereinabove. In various embodiments, a uniform coating of the plurality of carbon fibers includes between about 90 to 100% coverage of carbon nanotubes. In other various embodiments, a uniform coating of the plurality of carbon fibers includes between about 70% to about 90% coverage of carbon nanotubes. In various embodiments, a partial coating includes less than about 70% coverage of carbon nanotubes. FIG. 3 presents illustrative SEM images of uncoated carbon fibers (image 301), carbon fibers coated with unfunctionalized carbon nanotubes (image 302), carbon fibers coated with fluorinated carbon nanotubes (image 303) and carbon fibers coated with amine-functionalized carbon nanotubes (image 304). As can be seen from images 302 and 303, unfunctionalized carbon nanotubes and fluorinated carbon nanotubes provided relatively non-uniform coverage in which only a portion of the carbon fiber surface was covered with carbon nanotubes. Some agglomeration of the carbon nanotubes was observed on the fibers. In contrast image 304 showed more uniform coverage of the carbon fiber surface with the amino-functionalized carbon nanotubes. Image 305 presents an alternative view of the carbon fiber surface coated with the amino-functionalized carbon nanotubes. More uniform (i.e., greater) coverage of the carbon fibers in images 304 and 305 can be attributed to improved solubility and dispersibility of the amino-functionalized carbon nanotubes. Furthermore, more uniform coverage is achieved when the weight percentage of carbon nanotubes is increased. As the weight percentage of carbon nanotubes is increased, the coverage is thicker and more uniform. Depending on the solubility of the carbon nanotubes, the coating may include agglomerated carbon nanotubes.

In embodiments wherein the plurality of carbon fibers is a yarn or a sheet (fabric), interior portions of the yarn or sheet may not initially be coated with carbon nanotubes. However, during composite fabrication, at least a portion of the fibers in the interior of the yarn or fabric become coated with carbon nanotubes. The surface coating inhibits fiber-matrix debond cracking which would otherwise form normal to the fatigue loading source and propagate to the longitudinal or axial yarn-matrix interface. Axial cracking at the yarn matrix interface leads to delamination.

In various embodiments, the polymer composites disclosed herein are laminate materials. For example, in various embodiments, the fiber component is formed in a plurality of layers in the polymer composites. As used herein, a plurality of fiber layers will be used synonymously with the term “fabric layers”. In various embodiments, the polymer matrix component uniformly coats the plurality of fiber component layers. Applicants' definition of a uniform coating is set forth hereinabove. In various embodiments, a uniform coating of the plurality of fiber component layers exists when between about 90% and 100% of the fiber component layers are wetted with the polymer matrix component. In other various embodiments, a uniform coating of the plurality of fiber component layers exists when about 80% to about 90% of the fiber component layers are wetted with the polymer matrix component. In still other various embodiments, a uniform coating of the plurality of fiber component layers exists when about 70% to about 80% of the fiber component layers are wetted with the polymer matrix component. More uniform coatings of the fiber component layers with the polymer matrix component are advantageous, since a maximum interaction between the fiber component and the polymer matrix component occurs when the contact area of the fiber-matrix interface is maximized. Non-uniform coatings of the fiber component layers present a weak spot in the laminate materials, which then become more susceptible to failure and progression of fatigue defects. In various embodiments, the polymer matrix component is located between the plurality of layers. In other various embodiments, the polymer matrix component is located within the plurality of layers. In still other various embodiments, the polymer matrix component is located both between each of the plurality of layers and within each of the plurality of layers. In other words, the polymer matrix component lies both on the exterior and interior of each individual layers of fiber component. The polymer matrix component may be present within the layers, between the layers, or a combination thereof as an uncured epoxy and then subsequently cured.

In various embodiments, the polymer matrix component uniformly penetrates between each of the plurality of fiber component layers. As used herein, “uniformly penetrates or uniform penetration” refers to, for example, a condition in which the polymer matrix component is infiltrated through the plurality of fiber component layers before or during curing, such that the polymer matrix component is evenly disposed between each of the plurality of fiber component layers after curing. Such even dispersion of polymer matrix components advantageously provide a laminate material that is substantially free of voids and other defects after curing. Voids and defects include, for example, air bubbles trapped within the polymer matrix component after curing. Voids and other defects provide effects similar to non-uniform coverage of the polymer matrix component in that they present a weak spot in the polymer composite which is more susceptible to mechanical failure.

Since voids both on the surface and within the internal portions the polymer composites can lead to premature failure, assessment of such voids is a consideration to be made in assessing mechanical properties. In order to compare batch-to-batch properties of the polymer composites, means for detecting voids and imperfections have been established by Applicants. An illustrative and non-limiting means for evaluating the polymer composites is ultrasonic non-destructive evaluation (NDE). Ultrasonic NDE provides an assessment of the quality of the polymer composites through measurement of the amount of ultrasonic energy that is reflected by the polymer composites. Since reflection of ultrasonic waves is different in air (voids) than in a pristine polymer component matrix, returned signal strength can be diagnostic of voids within the polymer composite. For example, a region of high void volume will return a lower ultrasonic signal strength than will a region having relatively few air voids. Typical experimental conditions used for forming the CNFRPCs of the present disclosure include subjection of both the polymer matrix component and the fiber component to vacuum conditions for several hours to remove trapped air. As measured by ultrasonic NDE, the fiber components of the polymer composites described herein routinely have a fiber volume fraction of about 55%. One of ordinary skill in the art will recognize that fiber volume fractions either greater or less than this value may used to operate within the spirit and scope of the embodiments of the present disclosure.

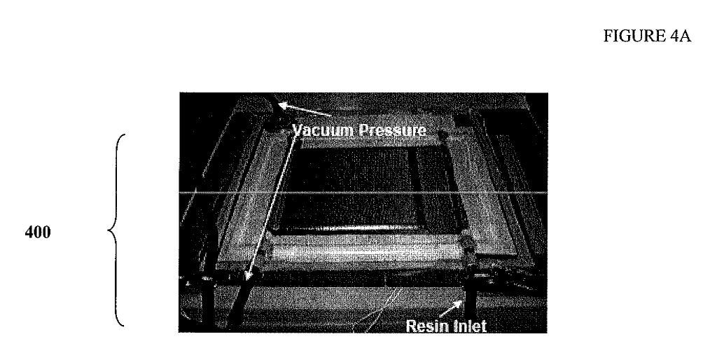

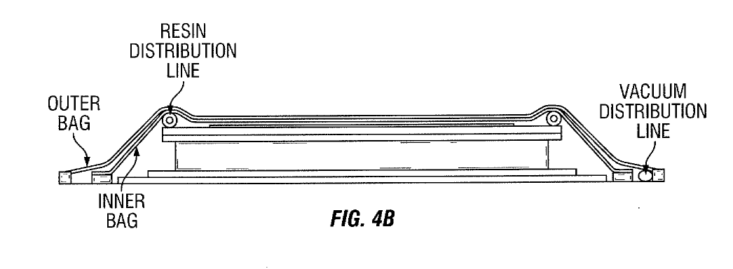

In various embodiments, the polymer composites disclosed herein are formed by a laying up process. Such laying up processes for forming laminate materials are known by those of ordinary skill in the art. An illustrative fiber lay up procedure is a High Temperature Vacuum Assisted Resin Transfer Molding (H-VARTM) system. FIG. 4 presents a photograph of an illustrative H-VARTM system 400, which was used to form the polymer composites of the present disclosure. FIG. 4B presents a side-view diagram of the illustrative H-VARTM system. For forming the polymer composites of the present disclosure, epoxy polymer infusion was conducted at about 250° C., and two curing cycles were performed thereafter. The first curing cycle was carried out at about 250° C. and the second at about 350° C. One of ordinary skill in the art will recognize that the infusion and curing temperatures are dependent on the epoxy polymer system chosen to form the polymer composite, and routine variation of temperatures and cycle times to produce a polymer composite having desired properties lies within the capabilities of one of ordinary skill in the art. Using the H-VARTM system, the uncured polymer matrix component penetrates between fiber component layers in a parallel fashion from side-to-side. FIG. 5 presents an illustration showing the direction of polymer matrix component penetration 501 through fiber component layers 502. During infusion of the polymer matrix component, the polymer matrix component is either cured or in the process of curing. In a typical orientation of the fiber component layers 502, alternating fiber layers or plies are orientated about 90° relative to one another. Such an orientation provides advantageous strengthening of the polymer composites and is referred to herein as a [0°,90°] ply orientation.

Other techniques for forming the polymer composites disclosed herein may be envisioned by those of ordinary skill in the art. For example, such the polymer composites may be formed using out-of-autoclave vacuum bag fabrication. Alternately or in combination, the fiber component may be coated with carbon nanotubes through, for example, a dip coating technique. As a still further alternative, the carbon nanotubes may be grown directly on the fiber component. For example, carbon nanotubes may be directly grown on a plurality of carbon fibers and may optionally be covalently bonded to the carbon fibers. Such alternative fabrication techniques reside within the spirit and scope of the present disclosure, and the embodiments described herein should not be considered limiting.

The polymer composites of the present disclosure are advantageous over conventional FRPCs in having increased fatigue failure lifetimes and enhanced mechanical properties. Increased fatigue failure lifetimes and enhanced mechanical properties of the CNFRPCs are measured relative to a reference FRPC not containing carbon nanotubes. Mechanical properties refer to, for example, tensile stiffness and tensile strength (elastic modulus). In various embodiments, the percentage increase in the mechanical properties is at least about 5%. In various embodiments, the percentage increase in the mechanical properties is at least about 10%. In other various embodiments, the percentage increase in the mechanical properties is at least about 20%. In still other various embodiments, the percentage increase in the mechanical properties is at least about 100%. The polymer composites of the present disclosure are particularly advantageous in their significantly enhanced fatigue failure lifetimes, particularly under tension-compression stress. In various embodiments, the percentage increase in fatigue failure lifetime is at least about 100%. In other various embodiments, the percentage increase in fatigue lifetime is at least about 1000%. In various embodiments, the polymer composites disclosed herein have increased fatigue failure lifetimes under tension-compression stress, wherein the increased fatigue failure lifetimes are measured relative to a reference polymer composite not including carbon nanotubes. In various embodiments, the polymer composites disclosed herein have increased fatigue failure lifetimes under tension-tension stress, wherein the increased fatigue failure lifetimes are measured relative to a reference polymer composite not including carbon nanotubes.

Applicants' current understanding of the increased fatigue failure lifetimes and enhanced mechanical properties is that improved load transfer occurs between the polymer matrix component and the fiber component in the polymer composites at the fiber-matrix interface when carbon nanotubes are present. In various embodiments of the polymer composites disclosed herein, the first quantity of carbon nanotubes transfers a load from the polymer matrix component to the fiber component. As currently understood by Applicants, carbon nanotubes, where present, are included in the fiber-matrix interface and facilitate a load transfer under stress from the polymer matrix component to the fiber component. The carbon nanotubes become an integral part of the fiber-matrix interface and form a first interface with the fiber component and a second interface with the polymer matrix component. Together with the polymer matrix component, the fiber component and the carbon nanotubes, where present, form a plurality of interfaces in the polymer composites that provide mechanical strengthening. In various embodiments, the plurality of interfaces includes interactions between a plurality of carbon fibers, the polymer matrix component and the first quantity of carbon nanotubes.

In some embodiments of the polymer composites disclosed herein, the polymer matrix does not contain additional carbon nanotubes. In other various embodiments, the polymer composites further include a second quantity of carbon nanotubes dispersed in the polymer matrix component. In various embodiments, the second quantity of carbon nanotubes includes, for example, single-wall carbon nanotubes, double-wall carbon nanotubes, multi-wall carbon nanotubes and combinations thereof. The second quantity of carbon nanotubes may be added to the polymer matrix component before being added to the fiber component. Alternately or in combination, the second quantity of carbon nanotubes may include carbon nanotubes partially leeched from the first quantity of carbon nanotubes coating the fiber component. In other words, some of the first quantity of carbon nanotubes may no longer coat the fiber component after formation of the polymer composites due to the leeching. Such leeching may occur during coating of the fiber component with the polymer matrix component. In various embodiments, the second quantity of carbon nanotubes is unfunctionalized (pristine). In other various embodiments, the second quantity of carbon nanotubes includes functionalized carbon nanotubes. In various embodiments, the second quantity of carbon nanotubes is at least partially bonded to the polymer matrix component. In various embodiments, the second quantity of carbon nanotubes is covalently bonded to the polymer matrix component. In various embodiments, the second quantity of carbon nanotubes is dispersed in the polymer matrix component. In other various embodiments, the second quantity of carbon nanotubes is integrated in the polymer matrix component. Illustrative methods for dispersing and integrating carbon nanotubes into a polymer are described in United States Patent Application Publication No. 20060047502, which is incorporated herein by reference in its entirety. In some embodiments of the polymer composites containing a second quantity of carbon nanotubes, the polymer matrix component is an uncured epoxy polymer. After covering the fiber component, the uncured epoxy polymer containing the second quantity of carbon nanotubes is cured. The cured polymer matrix component contains dispersed carbon nanotubes. When the polymer matrix contains a second quantity of carbon nanotubes, further strengthening of the fiber-matrix interface and the polymer matrix itself may be realized. Such strengthening may provide composites having still further improved mechanical properties and fatigue failure lifetimes.

In embodiments wherein the fiber component further includes a plurality of carbon nanofibers, there is an additional nanofiber-matrix interface between the carbon nanofibers and the polymer matrix component. In such embodiments, the carbon nanotubes are included in both the nanofiber-matrix interface and the fiber-matrix interface. Both the nanofiber-matrix interface and the fiber-matrix interface may aid in load transfer from the polymer matrix component to the fiber component.

In other various embodiments, laminate materials are disclosed herein. The laminate materials include a fiber component having a plurality of layers and a polymer matrix component coating the plurality of layers. The fiber component includes a plurality of carbon fibers. At least a portion of the fiber component is coated with a first quantity of carbon nanotubes. The polymer matrix component and the plurality of carbon fibers form a fiber-matrix interface. The fiber-matrix interface further includes the first quantity of carbon nanotubes. In various embodiments, the fiber component is uniformly coated with the first quantity of carbon nanotubes. In various embodiments, at least a portion of the plurality of carbon fibers are coated with the first quantity of carbon nanotubes. In various embodiments, the plurality of carbon fibers are uniformly coated with the first quantity of carbon nanotubes. In various embodiments, the fiber component includes layers of carbon fiber sheets (fabrics).

In various embodiments of the laminate materials, the polymer matrix component includes a thermosetting polymer. In various embodiments, the laminate material is formed by a laying up process. In various embodiments, the first quantity of carbon nanotubes is coated on to the fiber component by spraying a solution of carbon nanotubes on to the fiber component.

In various embodiments of the laminate materials, the first quantity of carbon nanotubes includes functionalized carbon nanotubes. In various embodiments, the first quantity of carbon nanotubes is covalently bonded to the polymer matrix component.

In various embodiments of the laminate materials, the laminate materials further include a second quantity of carbon nanotubes dispersed in the polymer matrix component. In various embodiments, the second quantity of carbon nanotubes includes functionalized carbon nanotubes. In various embodiments, the second quantity of carbon nanotubes is covalently bonded to the polymer matrix component.

In various embodiments of the laminate materials, the fiber-matrix interface is strengthened by the carbon nanotubes. In various embodiments, the fiber-matrix interface is strengthened by the first quantity of carbon nanotubes. In some embodiments, the fiber-matrix interface is strengthened by the second quantity of carbon nanotubes. In some embodiments, the fiber-matrix interface is strengthened by the first quantity of carbon nanotubes and the second quantity of carbon nanotubes. In some embodiments, the second quantity of carbon nanotubes strengthens the polymer matrix component.

In various embodiments of the laminate materials, the fiber-matrix interface is more resistant to fiber delamination and fatigue crack growth compared to a reference laminate material not including carbon nanotubes.

In various embodiments, methods for improving the fatigue durability of a fiber-reinforced polymer composite are disclosed. The methods include providing a plurality of sheets of carbon fibers, coating at least a portion of the each of the plurality of sheets with carbon nanotubes, layering the plurality of sheets after the coating step, and forming the fiber-reinforced polymer composite. The forming step includes substantially uniformly coating or wetting the plurality of sheets with a polymer after the layering step.

### EXPERIMENTAL EXAMPLES

The following experimental examples are included to demonstrate particular aspects of the present disclosure. It should be appreciated by those of skill in the art that the methods described in the examples that follow merely represent exemplary embodiments of the disclosure. Those of skill in the art should, in light of the present disclosure, appreciate that many changes can be made in the specific embodiments described and still obtain a like or similar result without departing from the spirit and scope of the present disclosure.

Materials: The CNFRPCs used in embodiments of the present disclosure include three primary components: EPON 862 epoxy, Hexel IM7 carbon fibers, and XD grade carbon nanotubes. In some embodiments, single-wall carbon nanotubes were utilized. The XD grade carbon nanotubes were prepared by CNI, Inc., Houston, Tex. and included about one-third each of single-wall, double-wall, and multi-wall carbon nanotubes. Reported properties of XD carbon nanotubes include a tensile strength of 11-600 GPa and an elastic modulus >1 TPa. The XD carbon nanotube diameters were in the range of about 1 nm to about 100 nm. The XD carbon nanotubes were fluorinated or amine-functionalized in preparation for spray coating of carbon fiber fabrics used in the laminate materials. Dispersion and spray coating techniques have been set forth previously hereinabove and are illustrated in FIG. 2. Spraying of the carbon nanotubes on to the carbon fiber fabrics was performed at NanoRidge Materials, Inc., Houston, Tex. Spraying was performed to target a 0.2 to 0.5 wt. % content of carbon nanotubes in the composite material. Fluorinated carbon nanotubes were sprayed to achieve target weight percents of 0.2, 0.3 and 0.5 weight percent. Amine-functionalized carbon nanotubes were sprayed to achieve target weight percents of 0.2 and 0.5 weight percent.

H-VARTM: H-VARTM was used to fabricate 10 to 12 ply epoxy-carbon fiber composite laminate panels. H-VARTM methods are described in R. L. Bolick, et al., “Innovative Composite Processing by Using H-VARTM© Method”, SAMPE Europe, 28th International Conference and Forums, Paris Porte de Versailles, France, April 2-4, 2007. The H-VARTM experimental apparatus has been previously shown in FIGS. 4A and 4B. All panels were measured for fiber volume fraction and for excessive porosity using ultrasonic NDE. A fiber volume fraction of approximately 55% was consistently achieved. The NDE evaluation procedure was applied to both FRPC and CNFRPC laminate panels.

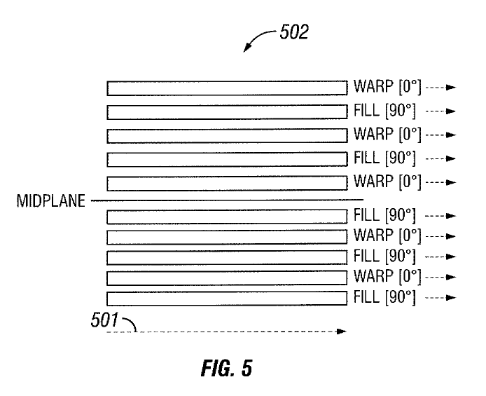

Testing specimens: FIGS. 6A and 6B present illustrative designs and dimensions for CNFRPC and FRPC specimens tested herein. To prepare the testing specimens, axial dogbone-type test specimens were cut from FRPC and FRPNC laminate panels. Specimen 601 was used in tension-tension fatigue testing. Specimen 602 was used in tension-compression fatigue testing.

### Example 1

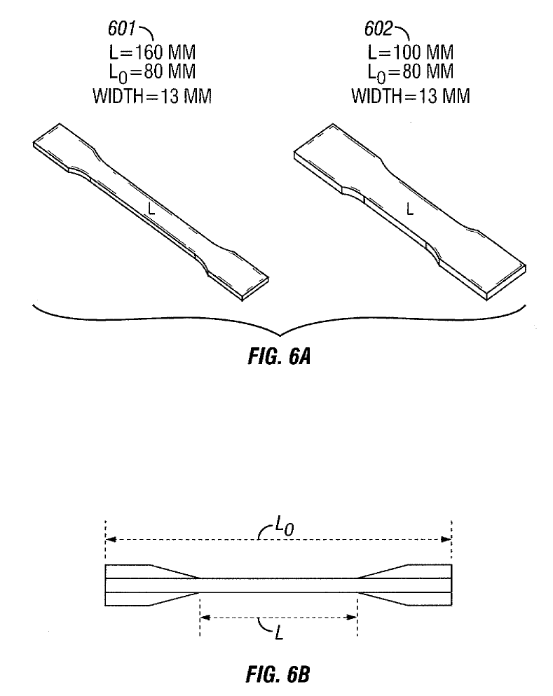

FIGS. 7A and 7B present an illustrative schematic of a simulated fatigue crack and an optical microscopy image of actual fatigue crack progression in CNFRPCs. Three layers of carbon nanotube coated carbon fibers are illustrated in FIG. 7A—two longitudinal layers 701 and one transverse layer 702 in a [0°,90°] ply orientation. As shown in FIG. 7B, normal fatigue crack progression is suppressed at the fiber-matrix interface where carbon nanotubes are present. Since fatigue crack progression leads to fiber-matrix longitudinal delamination, the carbon nanotubes enhance fatigue lifetime under both quasi-static and cyclical fatigue loading conditions, as will be illustrated below.

### Example 2

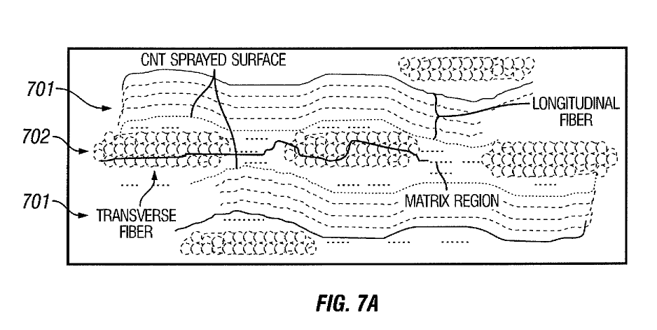

Controlled laboratory testing conditions may be used to evaluate the benefits of CNFRPCs over conventional FRPCs not containing carbon nanotubes coating the fiber component. As an initial test of the CNFRPCs, the tensile strength and tensile stiffness (elastic modulus) of CNFRPCs and FRPCs were evaluated and compared. Testing was conducted by ASTM testing methods D3039/D 3039/M. CNFRPCs utilized in the tensile strength and tensile stiffness studies contained about 0.2 to about 0.5 weight percent carbon nanotubes coating the carbon fibers. FIGS. 8A and 8B present graphical illustrations of the improvement in tensile stiffness (FIG. 8A) and tensile strength (FIG. 8B) observed in CNFRPCs compared to FRPCs not containing carbon nanotubes. Both tensile stiffness and tensile strength were improved in the CNFRPCs, particularly at higher weight percentages of carbon nanotubes. The improvement for both mechanical properties varied between 15 to 25 percent depending on the amount of carbon nanotubes used to coat the carbon fibers. Tensile fracture modes are considered hereinbelow.

### Example 3

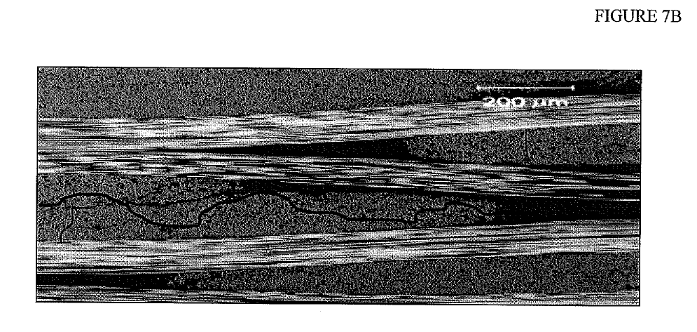

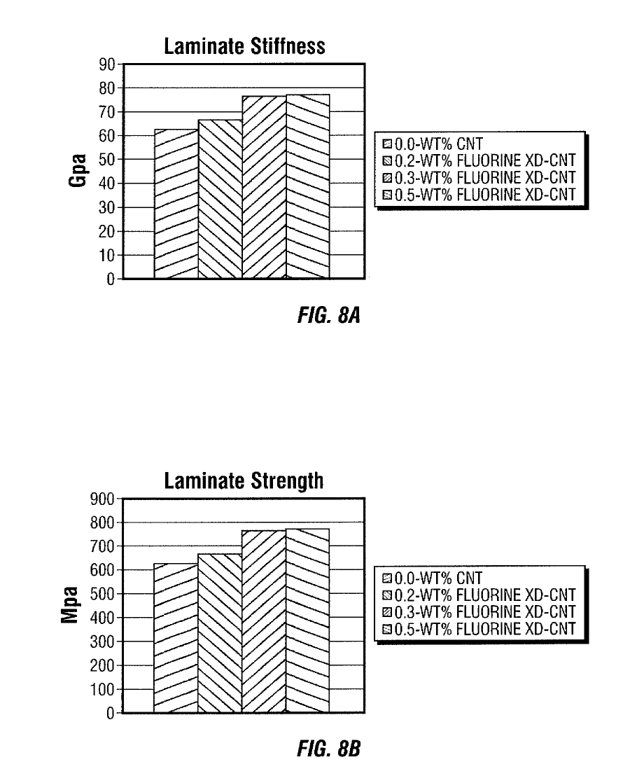

Laboratory testing was also conducted using a short beam shear (SBS) testing device for determining interlaminar shear cracking and failure, schematically illustrated in FIG. 9, using ASTM testing method D2344M-00. In the SBS test, a load 902 is applied perpendicularly to specimen 903. Midplane 901 is indicated on specimen 903. In a homogenous specimen, fatigue failure occurs at the midplane under SBS testing conditions in a longitudinal shear mode. To evaluate the role of carbon nanotubes in enhancing the resistance of CNFRPCs to interlaminar shear failure, SBS testing was conducted using CNFRPCs having carbon nanotubes coating the carbon fiber layers only on either immediate side of the midplane 901. Hence, the CNFRPCs utilized in the SBS testing methods were not homogenous (i.e., having all fiber layers coated with carbon nanotubes). Fracture modes observed for FRPCs compared to CNFRPCs in the SBS testing revealed certain details about the role of carbon nanotubes in reinforcing the fiber-matrix interface. FIG. 10 illustrates fracture modes observed for FRPCs and CNFRPCs under SBS testing conditions. Under SBS testing conditions, failure for both FRPCs and CNFRPCs occurred by tensile fiber rupture. As shown in FIG. 10, FRPC sample 1001 fractured at the midplane, which is consistent behavior for a homogenous material. In contrast, CNFRPC sample 1002 fractured away from the midplane, which provides evidence that the carbon nanotubes strengthen the fiber-matrix interface in the midplane carbon fiber layers, which are coated with carbon nanotubes. The increased strength of the fiber-matrix interface indicates that a change in observed failure mechanisms for CNFRPCs is likely compared to FRPCs.

### Example 4

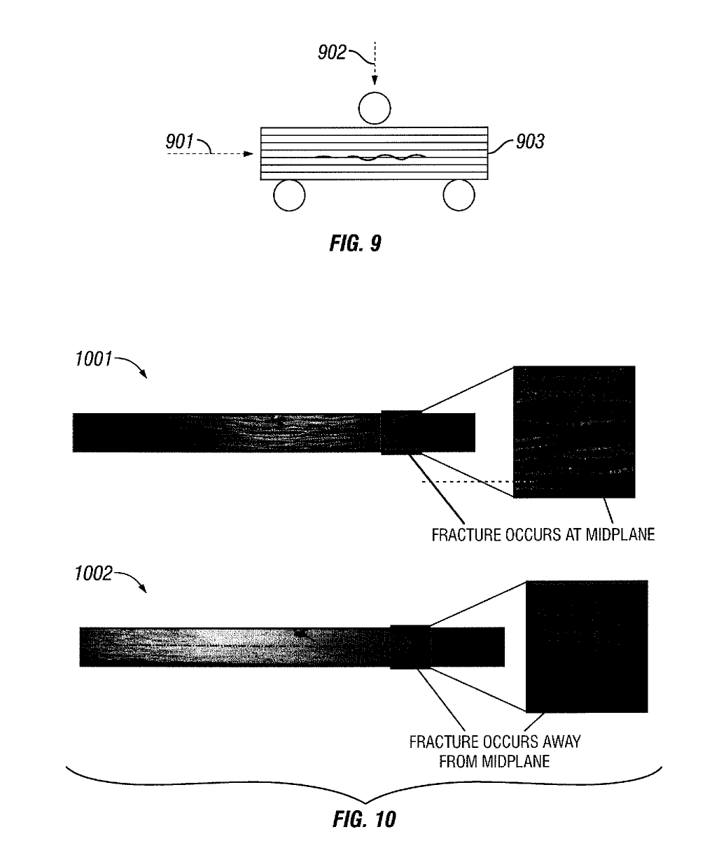

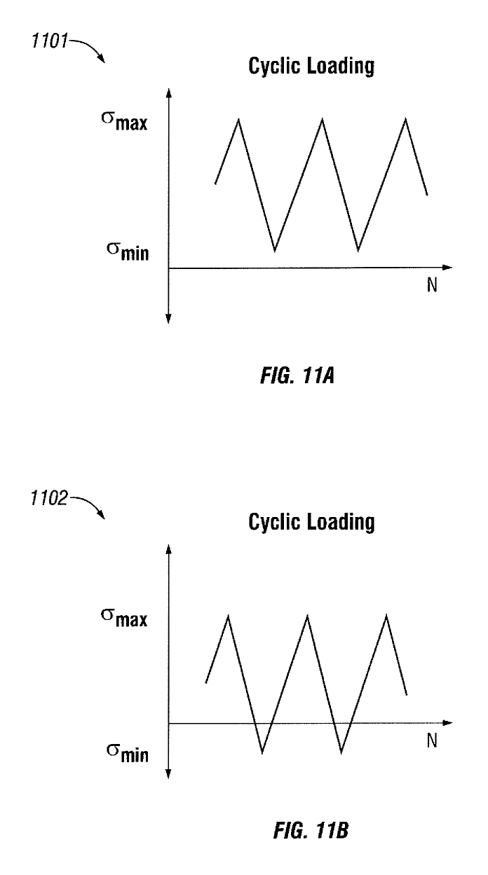

The CNFRPCs of the present disclosure are particularly advantageous in their significantly improved failure lifetimes under both tension-tension and tension-compression stress conditions, as compared to FRPCs not containing carbon nanotubes. FIGS. 11A and 11B present illustrative tension-tension and tension-compression stress cycles. σₘₐₓ and σₘᵢₙ are the maximum and minimum stresses, and the stress ratio R=σₘᵢₙ/σₘₐₓ is a measure of the difference between maximum and minimum stress. Tension-tension stress cycle 1101 and tension-compression stress cycle 1102 are used in a laboratory setting to determine the number of cycles required until specimen failure occurs due to fatigue. For tension-tension stress, the stress ratio is positive. For tension-compression stress, the stress ratio is negative since a compression is involved. Peak-to-peak or valley-to-valley measurement on the stress cycles constitutes one cycle N. FIGS. 12A and 12B present illustrative specimen displacements from the normal position under a tension-tension stress cycle 1201 and a tension-compression stress cycle 1202. As shown in FIGS. 12A and 12B, increased displacement from normal occurs as the number of cycles increases, which is indicative of a failure condition. Tension-tension and tension-compression stress ratios in the examples reported hereinbelow are about +0.1 and about −0.1, respectively. These stress ratios are illustrative of cyclical loading conditions found for military and commercial aircraft fuselages and like airfoils, and pressure vessel and piping systems of civil infrastructure, power generation and various energy applications. The values of the stress ratios are meant to convey the behavior of the polymer composites and should not be considered limiting. The polymer composites can be tested at tension-tension stress ratios of between about +0.1 and +1.0 and tension-compression stress ratios between about −0.1 and −1.0. Tension-tension and tension-compression stress testing presented herein was conducted at a testing frequency of 5 Hz.

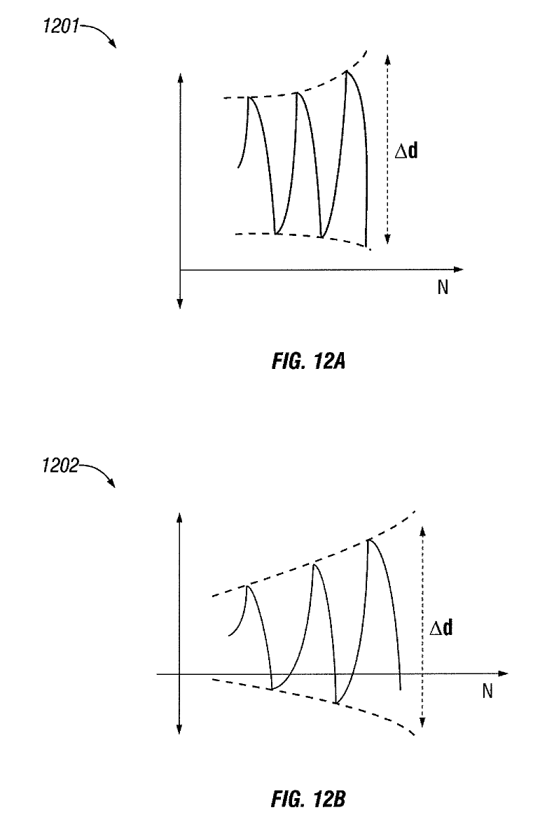

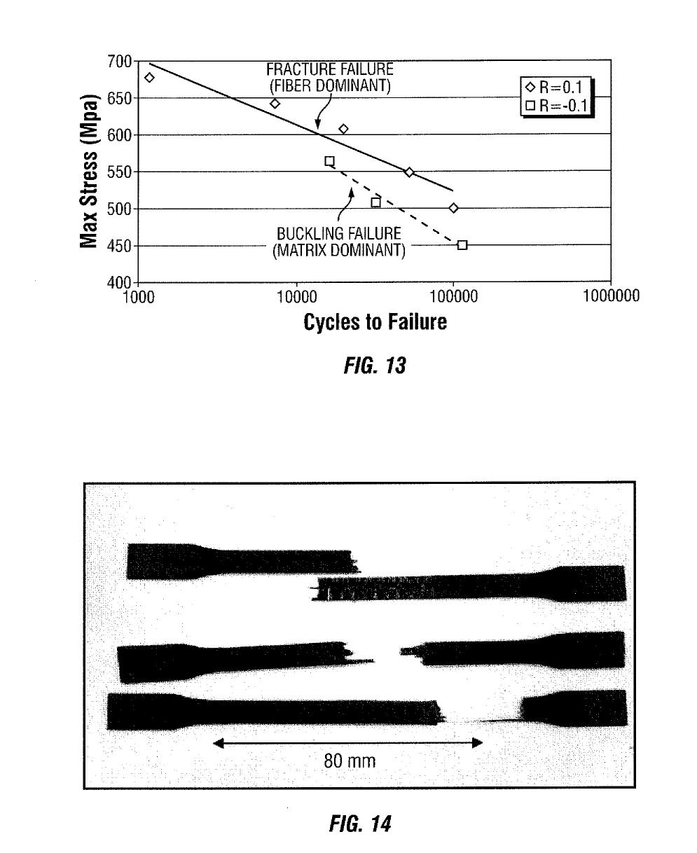

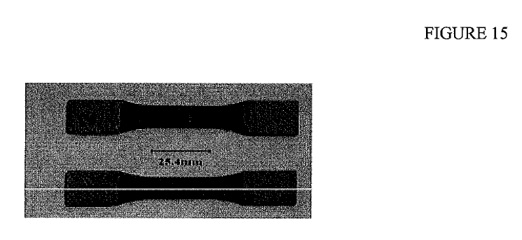

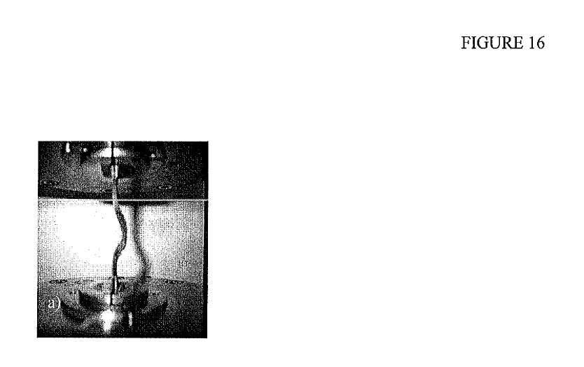

FIG. 13 presents an illustrative plot of the number of cycles required for fatigue failure to occur under various tension-tension and tension-compression stresses. The specimens tested in FIG. 13 were FRPCs not containing carbon nanotubes. Tension-tension fatigue testing was conducted by ASTM D3479/D 3479/M. As can be seen from FIG. 13, fatigue lifetime increased at lower maximum stresses, and for a comparable maximum stress, the tension-tension fatigue lifetime was greater than the tension-compression fatigue lifetime. For tension-tension cyclical stress (R=+0.1), fracture failure was the dominant failure mechanism. Tension-compression cyclical stress failure was more complex and is discussed in more detail hereinbelow. FIG. 14 presents illustrative specimens displaying fiber rupture under tension-tension stress. FIG. 15 presents illustrative specimens showing buckling failure under tension-compression stress. FIG. 16 presents an illustrative buckled specimen in the tension-compression testing apparatus.

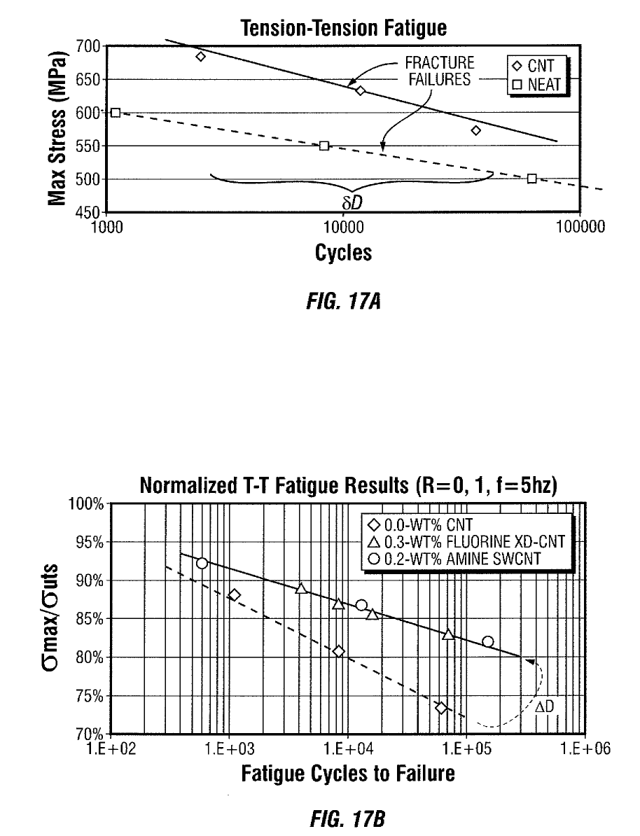

CNFRPCs displayed superior tension-tension failure lifetimes compared to FRPCs not containing carbon nanotubes. FIGS. 17A and 17B present illustrative plots of the tension-tension failure lifetimes of CNFRPCs compared to FRPCs not containing carbon nanotubes. In FIG. 17A, δD represents the fatigue durability, the increase in fatigue lifetime observed between two materials at an equal maximum stress. The fatigue durability increase of CNFRPCs (0.2 weight percent of fluorinated carbon nanotubes) compared to FRPCs not containing carbon nanotubes was approximately 1000%. FIG. 17B illustrates a like fatigue durability increase in CNFRPCs containing 0.3 weight percent fluorinated carbon nanotubes and 0.2 weight percent amino-functionalized carbon nanotubes.

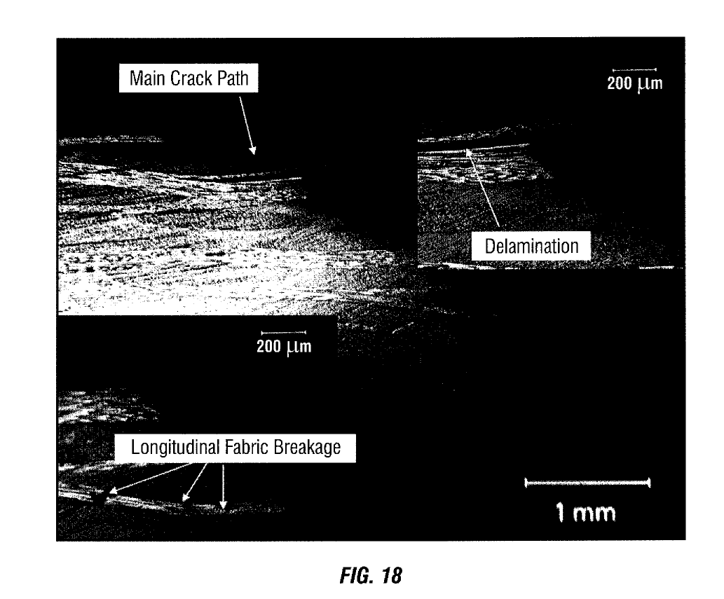

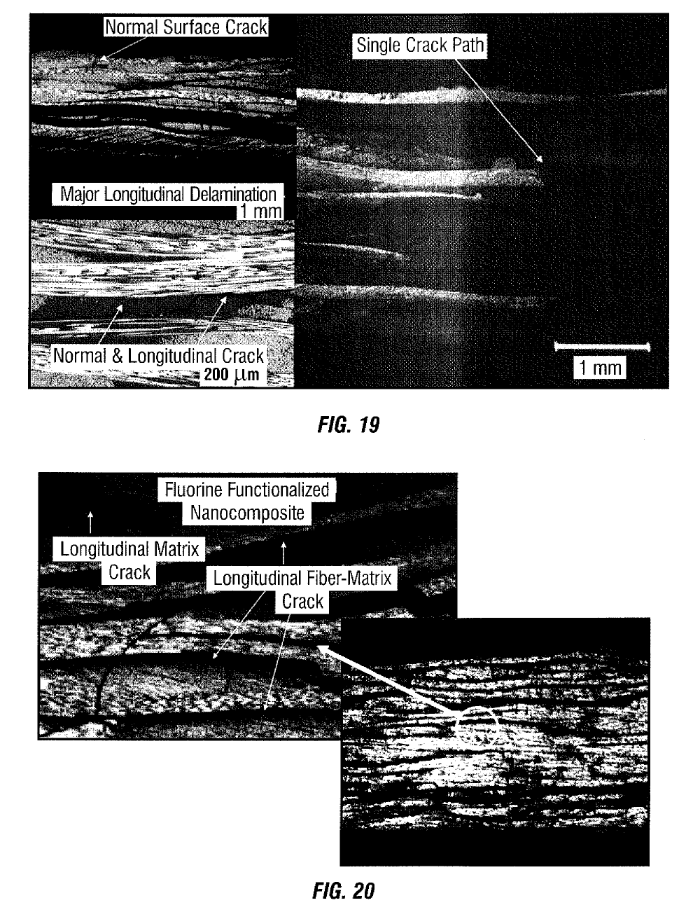

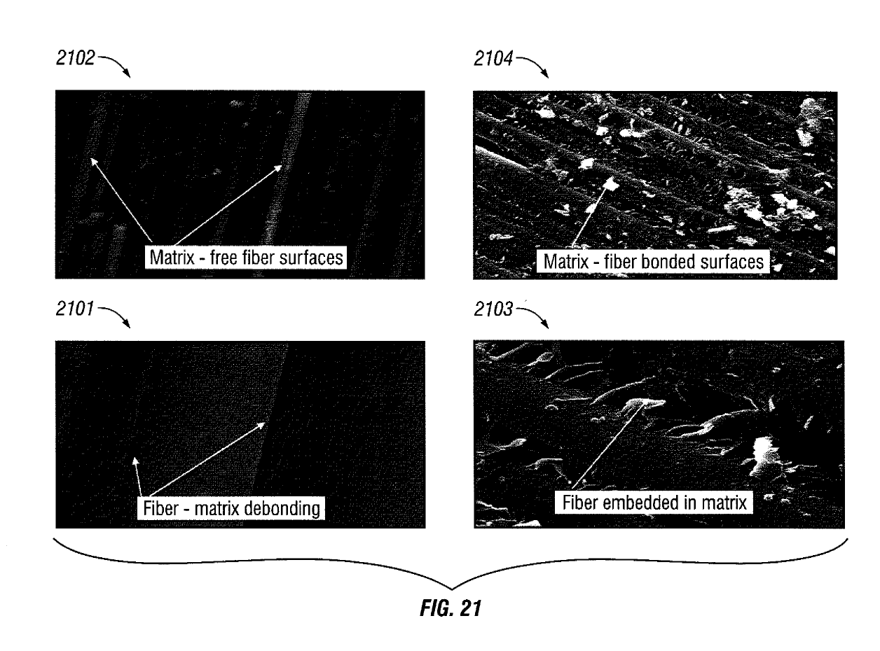

Microscopic analyses of the samples failed under tension-tension stress were also conducted to further ascertain the mechanism of fracture failure. FIG. 18 presents illustrative optical microscopy images of a failed specimen from quasi-static tensile testing. As shown in FIG. 18, failure was localized in a region of the main crack path. Microscopic observations further showed fabric breakage and delamination prior to specimen rupture. In contrast to FRPCs, CNFRPCs advantageously had reinforced fiber-matrix interfaces, mitigating fabric breakage and delamination. FIG. 19 presents illustrative optical microscopy images of FRPCs showing normal and longitudinal crack progression along the fiber-matrix interface under tension-tension stress. The optical microscopy images of FIG. 19 indicate that tension-tension fatigue failure occurs by normal matrix cracking and fiber-matrix delamination, leading to a structurally unstable failure leading to fiber overload and final rupture. Tension-tension fatigue cracking constitutes a structurally-stable failure. In contrast, buckling failures are structurally unstable. FIG. 20 presents an illustrative optical microscopy image for CNFRPCs showing longitudinal crack progression under tension-tension stress. Although longitudinal crack progression was still present in CNFRPCs under tension-tension stress, some cracking was observed that occurred at about 45° to the longitudinal direction. Like behavior was not seen in the FRPCs not containing carbon nanotubes. Applicants present evidence hereinbelow that diversion of the cracking from the fiber matrix interface occurs due to interference of crack progression by the carbon nanotubes coated on the fiber component. The greater matrix microstructure damage experienced by CNFRPCs prior to fracture failure under tension-tension stress is suggestive of a greater load transfer from the polymer matrix to the fiber component than occurs in FRPCs not containing carbon nanotubes. Although CNFRPCs still experience damage under stress, the damage constitutes structurally stable failures which are dominated by fiber failure rather than matrix dominated failure. Furthermore, since a greater extent of microscopic structurally-stable failures occur in CNFRPCs compared to FRPCs, failure can be assayed more readily by non-destructive methods such as, for example, ultrasonic NDE. Once a threshold level of microscopic structural failures occurs and is detected by ultrasonic NDE, a component can then be replaced prior to ultimate macroscopic structural failure.

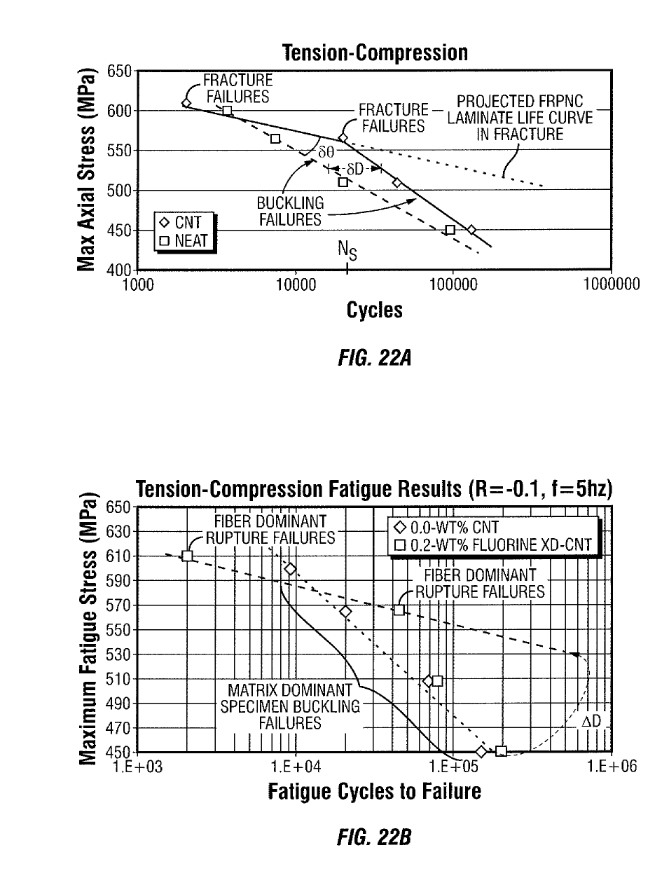

FIG. 21 presents illustrative SEM images of the fracture surfaces of FRPCs not containing carbon nanotubes and CNFRPCs following failure under tension-tension stress. Images 2101 and 2102 indicated that the fibers having no carbon nanotube coating had little interaction with the matrix. Images 2101 and 2102 further showed indications of fiber-matrix debonding. In contrast, images 2103 and 2104 for CNFRPCs suggested a significant amount of interaction between the fibers and the matrix during the failure process. The fiber-matrix interaction contributed to the increased fatigue failure lifetime as a consequence of carbon nanotube reinforcement of the fiber-matrix interfaces.

### Example 5

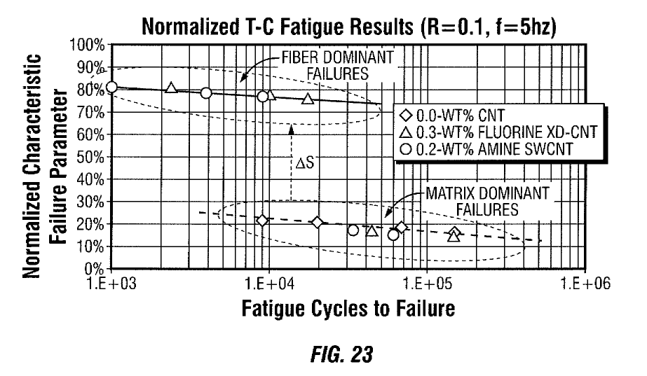

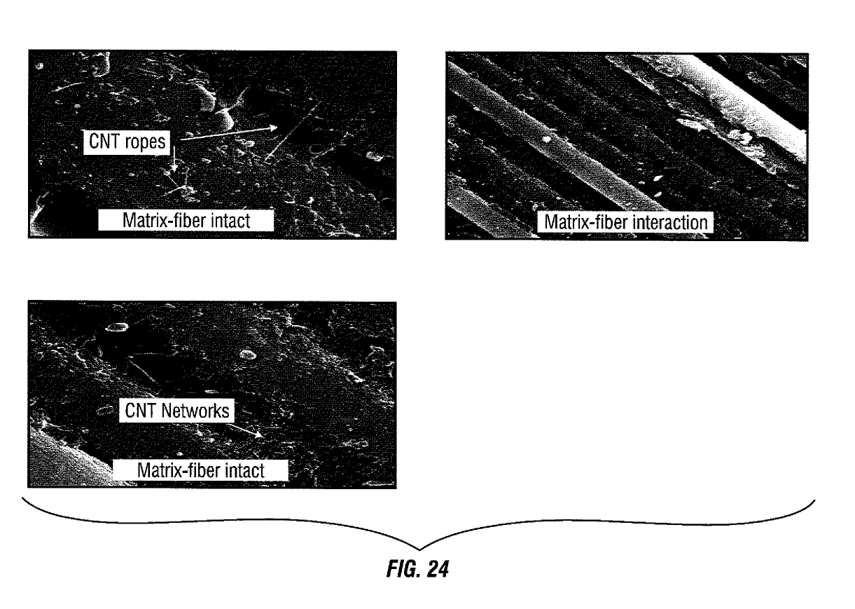

CNFRPCs also displayed superior failure lifetimes under tension-compression stress compared to FRPCs not containing carbon nanotubes. FIGS. 22A and 22B present illustrative plots of the increase in fatigue failure lifetime of CNFRPCs compared to FRPCs not containing carbon nanotubes. Tension-compression fatigue testing was conducted with specimens containing 0.2 or 0.3 weight percent fluorinated carbon nanotubes or 0.2 weight percent amino-functionalized carbon nanotubes. Although the fatigue durability increase, δD, was considerably lower for CNFRPCs under tension-compression stress compared to tension-tension stress, the increase remained measurable compared to FRPCs not containing carbon nanotubes. The failure lifetime plot shown in FIGS. 22A and 22B is non-linear due to competing modes of failure in CNFRPCs at various fatigue lifetimes, as is discussed in more detail below. As shown in the normalized tension-compression fatigue failure plot of FIG. 23, fiber-dominant failures and matrix-dominant failures are predominant at different cycle lifetimes. In contrast, FRPCs did not display the competing failure modes in fatigue, which provides further evidence of the role of carbon nanotubes in strengthening the fiber-matrix interface.

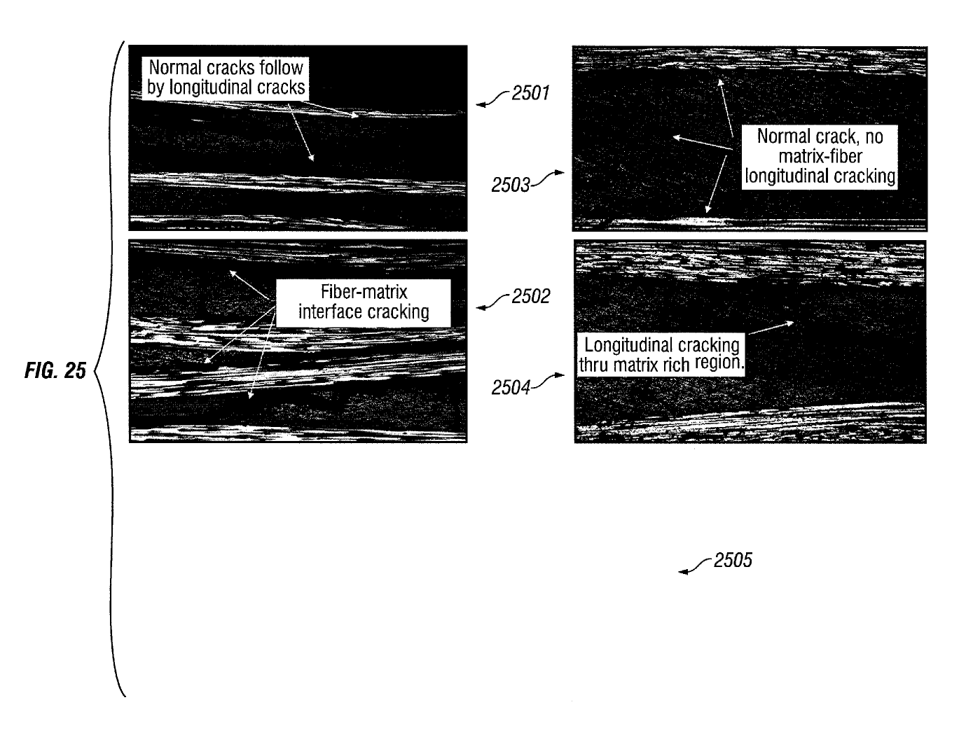

Failure of the FRPCs occurred in all cases via fiber buckling and subsequent specimen buckling due to fiber-matrix delamination. In contrast, the CNFRPCs displayed improved structural stability under tension-compression stress, and ultimate failure generally occurred by fracture rather than by buckling at shorter failure lifetimes. Failure by fracture is indicative of strengthening of the fiber-matrix interface by the carbon nanotubes, resulting in enhanced load transfer from the matrix to the carbon fibers. FIG. 24 presents illustrative SEM images of the fracture surface in CNFRPCs under tension-compression stress. As evidenced by the SEM images, the carbon nanotubes strengthen the fiber-matrix interface. The fracture images are comparable to the fracture images observed after tension-tension failure that are presented in FIG. 21. In summary, the carbon nanotubes improve fatigue durability under tension-compression stress by delaying the onset of buckling-related failures in CNFRPCs.

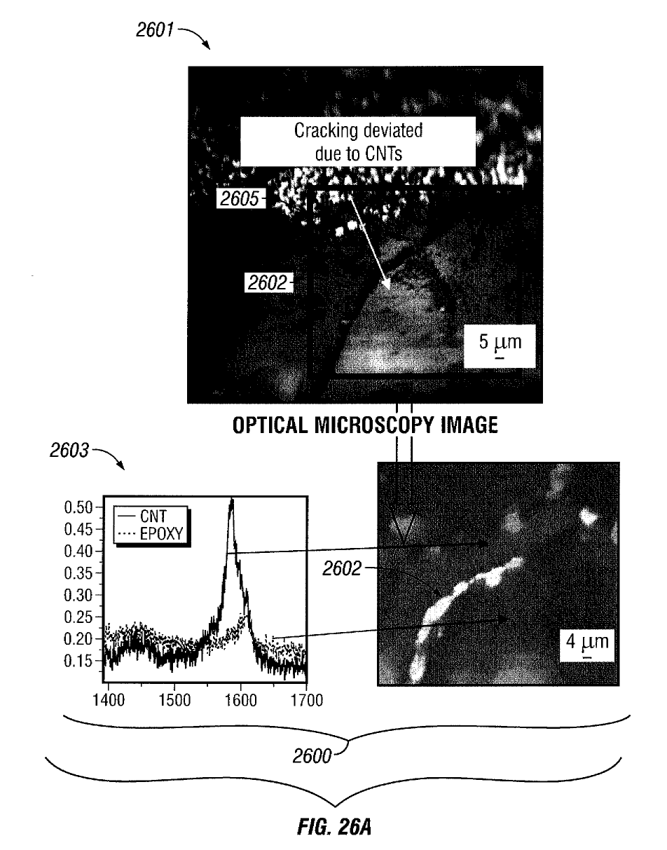

At longer fatigue failure lifetimes, the CNFRPCs eventually failed by a buckling mechanism. FIG. 25 presents illustrative midplane optical microscopy images of FRPCs and CNFRPCs following buckling failure under tension-compression stress. As shown in images 2501, 2502 and 2505, FRPCs not containing carbon nanotubes demonstrated fiber-matrix interface longitudinal cracking in addition to matrix-only cracking. In contrast, images 2503 and 2504 demonstrated limited fiber-matrix interface cracking. Cracking in CNFRPCs tended to occur in a matrix-rich region not containing carbon nanotubes. Such behavior is indicative of the influence that carbon nanotubes have in strengthening the fiber-matrix interface in CNFRPCs.

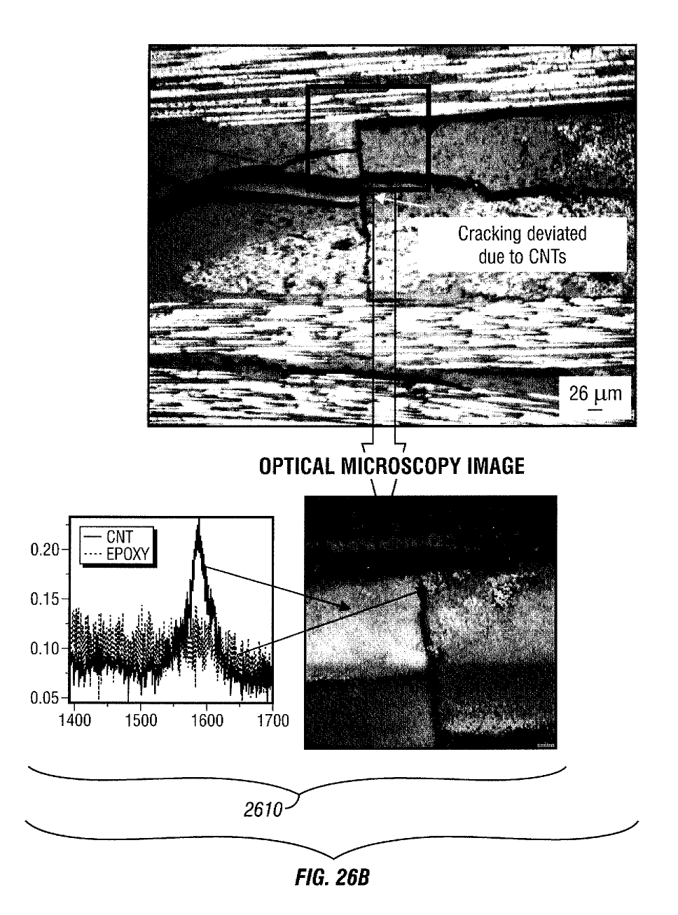

In some cases, cracking in the CNFRPCs was diverted from regions containing carbon nanotubes. For example, longitudinal fiber-matrix interface cracking can be diverted away from the fiber-matrix interface by the presence of carbon nanotubes. The presence of carbon nanotubes is readily indicated in the solid phase by their unique Raman spectroscopy signature. FIG. 26 presents illustrative Raster Scan Raman spectra and optical microscopy images of the polymer composites in the immediate vicinity of fatigue cracks. Combined images 2600 and 2610 are presented. As shown in combined image 2600, crack 2602 was diverted from fiber-matrix interface 2605 in optical microscopy image 2601. The inset shows an enhanced optical microscopy image in the immediate vicinity of crack 2602. Raster Scan Raman spectrum 2603 showed that carbon nanotubes were present at fiber-matrix interface 2605 where crack 2602 was diverted. Before the crack was diverted, the Raster Scan Raman spectrum detected no carbon nanotubes. Similar behavior was seen in the crack shown in combined image 2610.

### Prophetic Example

Applicants contemplate that a more structurally stable polymer composite can be prepared by improving the carbon nanotube deposition method to obtain more complete coverage of the fiber components. Further, Applicants contemplate that using higher weight percentages of carbon nanotubes, carbon nanotubes having different functionalization, or different nanoconstituents entirely. As presently understood by Applicants, carbon nanotubes strengthen the fiber-matrix interface in the polymer composites. Hence, improved strengthening of the fiber-matrix interface by any of the above modifications or a combination thereof will result in a polymer composite having an increased fatigue failure lifetime. In various embodiments, the tension-tension or tension-compression fatigue lifetimes of the polymer composites will be enhanced by optimizing the quantity of carbon nanotubes. In various embodiments, the tension-tension or tension-compression fatigue lifetimes of the polymer composites will be enhanced by optimizing the type of carbon nanotubes. For example, single-wall, double-wall, multi-wall carbon nanotubes or a combination thereof may be used. In still other various embodiments, the tension-tension or tension-compression fatigue lifetimes of the polymer composites will be optimized by changing the functionalization chemistry of the carbon nanotubes. For example, through optimizing the functionalization chemistry, more uniform coating of the fiber component with the carbon nanotubes will be realized in order to obtain optimal strengthening of the fiber-matrix interface. As a consequence of any of these further improvements, an unstable failure mode will be delayed until later in life, satisfying a design objective of the polymer composites. For example, optimization of the carbon nanotube composition forming the fiber-matrix interface will further delay the onset of buckling failures under tension-compression stress and provide a composite material having tension-tension and tension-compression fatigue durabilities of comparable magnitude.

From the foregoing description, one of ordinary skill in the art can easily ascertain the essential characteristics of this disclosure, and without departing from the spirit and scope thereof, can make various changes and modifications to adapt the disclosure to various usages and conditions. The embodiments described hereinabove are meant to be illustrative only and should not be taken as limiting of the scope of the disclosure, which is defined in the following claims.

What is claimed is the following:

1. A polymer composite, comprising:
a fiber component;
a polymer matrix component;
wherein the polymer matrix component and the fiber component form a fiber-matrix interface; and
a first quantity of carbon nanotubes;
wherein the first quantity of carbon nanotubes coats at least a portion of the fiber component; and
wherein the first quantity of carbon nanotubes further comprises the fiber-matrix interface.

2. The polymer composite of claim 1, wherein the fiber component comprises a plurality of carbon fibers.

3. The polymer composite of claim 2, wherein the first quantity of carbon nanotubes coats at least a portion of the plurality of carbon fibers.

4. The polymer composite of claim 1, wherein the polymer component comprises an thermosetting polymer.

5. The polymer composite of claim 1, wherein the fiber component comprises a plurality of layers.

6. The polymer composite of claim 5, wherein the polymer matrix component uniformly coats the plurality of layers.

7. The polymer composite of claim 5, wherein the polymer matrix component is uniformly dispersed between each of the plurality of layers.

8. The polymer composite of claim 1, wherein the first quantity of carbon nanotubes is coated on to the fiber component by spraying.

9. The polymer composite of claim 1, wherein the first quantity of carbon nanotubes comprises functionalized carbon nanotubes.

10. The polymer composite of claim 1, wherein the first quantity of carbon nanotubes is covalently bonded to the polymer matrix component.

11. The polymer composite of claim 1, further comprising:
a second quantity of carbon nanotubes;
wherein the second quantity of carbon nanotubes is dispersed in the polymer matrix component.

12. The polymer composite of claim 1, wherein the polymer composite has an increased fatigue life under tension-compression stress;
wherein the increased fatigue life is measured relative to a reference polymer composite not comprising carbon nanotubes.

13. The polymer composite of claim 1, wherein the first quantity of carbon nanotubes transfers a load from the polymer matrix component to the fiber component.

14. A laminate material, comprising:
a fiber component comprising a plurality of layers;
wherein the fiber component comprises a plurality of carbon fibers; and
wherein at least a portion of the fiber component is coated with a first quantity of carbon nanotubes; and
a polymer matrix component uniformly dispersed between the plurality of layers;
wherein the polymer matrix component and the plurality of carbon fibers comprise a fiber-matrix interface;
wherein the first quantity of carbon nanotubes further comprises the fiber-matrix interface.

15. The laminate material of claim 14, wherein the polymer matrix component comprises a thermosetting polymer.

16. The laminate material of claim 14, wherein the first quantity of carbon nanotubes comprises functionalized carbon nanotubes.

17. The laminate material of claim 14, wherein the first quantity of carbon nanotubes is covalently bonded to the polymer matrix component.

18. The laminate material of claim 14, wherein the first quantity of carbon nanotubes is coated on to the fiber component by spraying a solution of carbon nanotubes on to the fiber component.

19. The laminate material of claim 14, further comprising a second quantity of carbon nanotubes;
wherein the second quantity of carbon nanotubes is dispersed in the polymer matrix component.

20. The laminate material of claim 14, wherein the fiber-matrix interface is strengthened by the first quantity of carbon nanotubes.

21. The laminate material of claim 14, wherein the fiber-matrix interface is more resistant to fiber delamination and fatigue crack growth compared to a reference laminate material not comprising carbon nanotubes.

22. A method for improving the fatigue durability of a fiber-reinforced polymer composite, said method comprising:
providing a plurality of sheets of carbon fibers;
coating at least a portion of the each of the plurality of sheets with carbon nanotubes;
layering the plurality of sheets after the coating step; and
forming the fiber-reinforced polymer composite;
wherein the forming step comprises substantially uniformly coating the plurality of sheets with a polymer after the layering step.
